(19) United States
(12) Patent Application Publication
(10) Pub. No.: US 2004/0220841 A1
(43) Pub. Date: Nov. 4, 2004

(54) Alerting system

(76) Inventor: William Fairweather, Rockville, MD (US)

Correspondence Address: HARNESS, DICKEY & PIERCE, P.L.C., P.O. BOX 8910, RESTON, VA, 20195, US

(21) Appl. No.: 10/425,826

(22) Filed: Apr. 30, 2003

(51) Int. Cl. G06F 17/60; G01C 21/34

(52) U.S. Cl. 705/5; 705/6; 701/201; 701/202

(57) ABSTRACT

In a method for an alerting system for travelers, a processing center receives travel itinerary information from a subscriber. The travel itinerary information includes a destination arrival time. The processing center sends a processor message to a recipient other than the subscriber when a cancellation message is not received from the subscriber prior to a predetermined period of time after the destination arrival time. The processor message includes a portion of the travel itinerary information.

### BACKGROUND OF THE INVENTION

1. Technical Field

The present invention relates generally to an alerting system for travelers.

2. Related Art

The US Coast Guard, state police, other state and Federal agencies, private insurance companies, and others recommend that boaters file a float plan prior to traveling by boat. Float plans often include a traveler's information including a destination arrival time. Model float plans are available and some web sites assist in filling out the plans. However, few boaters actually file float plans routinely. Moreover, the float plans are typically not universal and are limited to travel within a particular jurisdiction, requiring a boater to obtain and fill out a float plan for each jurisdiction the boater may travel through.

### SUMMARY OF THE INVENTION

The invention provides a method comprising receiving, by a processing center, travel itinerary information from a subscriber, the travel itinerary information including a destination arrival time. The method additionally includes sending, by the processing center, a processor message to a recipient other than the subscriber when a cancellation message is not received from the subscriber prior to a predetermined period of time after the destination arrival time, the processor message including a portion of the travel itinerary information. The processor message may be an electronic message that is created when the cancellation message is not received from the subscriber prior to a predetermined period of time after the destination arrival time. Moreover, the processor message may be at least one of an email, telephone call, facsimile, video, pager message, or wireless transmission. Furthermore, the travel itinerary information includes at least one of boating travel itinerary information and a vessel picture.

The method may further comprise storing subscriber information and a recipient list in a database. Furthermore, the method may further include retrieving a portion of the subscriber information and a portion of the recipient list from the databases. Moreover, the processor message may include a portion of the subscriber information. The sending of the processor message may be to at least one recipient on the recipient list. Furthermore, the processing center may include at least one of a plurality of computers and a plurality of databases.

Additional features and advantages of the invention will be more fully apparent from the following detailed description of example embodiments, the appended claims and the accompanying drawings.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an example block diagram of an alerting system according to an embodiment of the invention;

FIG. 2 is an example menu mapping for the alerting system according to an exemplary embodiment of the invention;

FIG. 3 shows an example screen shot for adding vessel information according to an embodiment of the invention;

FIG. 4 is an example flow chart for declaring an emergency and canceling a float plan via a PC and web server according to an embodiment of the invention;

FIG. 5 is an example flow chart of notifying recipients according to an embodiment of the invention; and

FIGS. 6 and 7 are example alerting processor messages according to an embodiment of the invention.

### DETAILED DESCRIPTION OF EXEMPLARY EMBODIMENTS

The alerting system as described provides a convenient, unobtrusive, universally applicable notification system that does not involve anyone not aboard the vessel (eg, friends and family of the boating party, commercial boat owner, etc) until a vessel is overdue.

The invention provides a World Wide Web, facsimile, and telephony based electronic notification system for subscribers, which allows the subscribers to set up a mass mailing of formatted, highly informative alerting processor messages that are sent when the boater fails to cancel the mailing before a specific time or the subscriber asserts that a boater is in an emergency situation.

The invention also provides added information security. Because mass mailing systems are subject to unauthorized hacking and spamming, the invention includes a system for data entry that is separate from a system that generates and sends the alerting processor messages. In part, because of this separation, the invention limits what data an outside party may access, prevents the subscriber from accessing data that is not the subscriber's own, and limits the number of recipients of alerting processor messages.

The invention provides many benefits that are likely to encourage the filing of float plans and, as a result, help make both recreational and commercial boating safer.

The alerting system includes several processing components and performs several functions including interfacing with a subscriber, allowing a subscriber to modify a float plan, and notifying recipients. Each of the components and functions will be described in detail below.

Alerting System Architecture

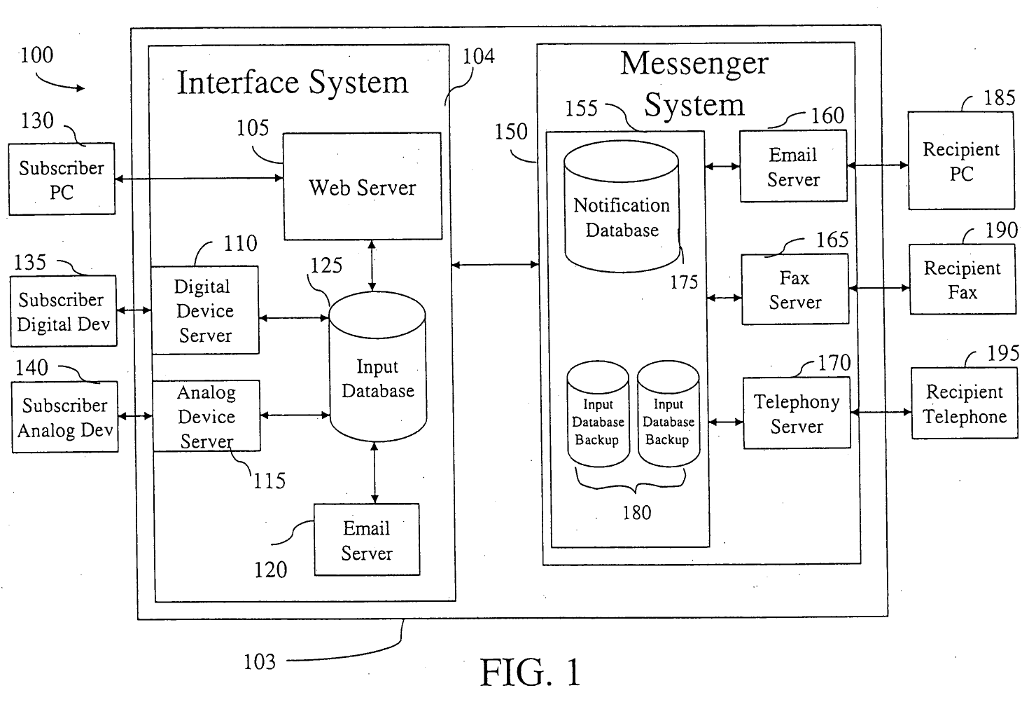

FIG. 1 is an example block diagram of an alerting system according to an embodiment of the invention. FIG. 1. shows an alerting system 100 that includes a processing center 103 configured to be connected to a subscriber personal computer (PC) 130, a subscriber digital device 135, subscriber analog device 140, a recipient PC 185, recipient fax 190, and recipient telephone 195.

The processing center 103 primarily receives input from the subscriber personal computer 130, subscriber digital device 135, and subscriber analog device 140. Output of the processing center 100 is primarily to a recipient PC 185, recipient fax 190, and recipient telephone 195.

The processing center 103 includes an interface system 104, which primarily receives user travel itinerary information and connects to a messenger system 150. The messenger system 150 primarily outputs messages associated with the subscriber's travel itinerary information. While the processing center shows the interface system 104 and the messenger system 150 logically close together, they actually may be in different locations and connected via the Internet or other network system.

In addition to the above connectivity, the interface system 104 includes an input database 125 that connects to and receives input from a web server 105, digital device server 110, an analog device server 115, and an email server 120. The input database 125 stores information related to the subscriber such as administrative and financial information, vessel information, crew information, home port information, notification recipient information, float plans, and digital images of vessels. Dates and times are local dates and times and contain an indication of whether Daylight Savings Time applies.

The web server 105 serves web pages to the subscriber PC 130 either directly or over a network (not shown) such as the Internet. The web pages assist the subscriber in navigating through the alerting system 100 and provide an input interface through which the subscriber may input travel itinerary information and account information into the input database 125. The web server 105 resides on a computing platform such as a PC running the Microsoft NT operating system or UNIX derivative operating system. The web pages include information about the alerting system, input screens, and access to subscriber accounts. While a subscriber PC 130 is shown, any device such as a cellular phone, PDA, etc. that is able to receive and process web pages may also be used to connect to the web server 105.

The digital device server 110 is an interface that guides a user through a menu system enabling a subscriber to input travel itinerary and account information into the database 125 using a subscriber digital device 135 such as digital wireless phone. The digital device server 110 and subscriber digital device 135, may be connected directly as shown or indirectly via a network such as a telephone network (not shown). For example, a subscriber may call into the digital device server 110 and be greeted by an automated attendant that walks the subscriber through a list of menus. The subscriber, using his/her phone keypad or voice may input information in response to menu questions asked by the automated attendant. The digital device server 110 interprets the subscriber inputs into either commands to continue through the menus or information that is compatible for storage into the input database 125.

The analog device server 115 performs the same functions as the digital device server 110 except that it receives its input from a subscriber analog device 140 such as an analog telephone. Alternatively, the subscriber analog device 140 might also be a radio system. The analog device server 115, like the digital device server 110, also may be connected directly as shown or indirectly via a network such as a telephone network (not shown). While two separate systems 110 and 115 are shown to support analog and digital functionality, one device may be used that is capable of interpreting both analog and digital signals.

Alternatively, operative personnel of the processing center 103 may receive subscriber information from the subscriber and input it directly into the input database 125.

The email server 120 may be a Microsoft Outlook Email Server that sends information to the subscriber such as account information, system updates, and billing information. The Email server 120 also receives input from the subscriber using a formatted message.

The messenger system 150 includes a notification processor 155 that is connected to and provides output to an Email server 160, a fax server 165, and a telephony server 170. The notification processor 155 includes a notification database 175 and input database backup 180. The notification processor 155 receives most of its input from the interface system 104. The notification processor 155 resides on a server platform such as a Sun Microsystems Sun Fire Server running a Sun Microsystems Solaris operating system or other operating system. The notification processor 155 provides the logic for the alerting system 100 that sends messages and stores information needed by the alerting system 100 for the message content.

The notification processor 155 primarily uses the notification database 175 to provide the information needed to send alerting processor messages. The notification processor 155 converts the local dates and times stored in the input database 125 to the local time of the notification processor 155, including the presence of Daylight Savings Time at both locations. The notification database 175 may be an Oracle Database or other database residing on the notification processor. The notification database 175 includes travel itinerary and subscriber records that may be chronologically ordered such as information related to administrative and financial actions, activities log information, float plans that have been filed, overdue vessel notifications that have been made, float plans that have been canceled, queries of the input database 125 by notification software and results (available or not), system errors, audit trails, and administrative reports made.

The notification processor 155 also assists in providing redundancy for the alerting system 100 by including at least one copy of the input database 125 in the input database backup 180.

The notification processor 155 uses the Email Server 160, the fax server 165, and the telephony server 170 to send alerting processor messages to a recipient's PC 185, Fax 190, or telephone 195. The Email Server 160 may be a Microsoft Outlook Server or other Email system. It is used to Email the alerting processor messages to recipients on a recipient list. The Emails are messages including information about the subscriber and the subscriber's travel itinerary information. The Email messages may be digitally signed to enhance message authenticity and integrity. The fax server 165 and telephony server 170 are similarly used. In the case of the telephony server, however, an automated assistant may be used to contact the alerting processor message recipient. A radio system (not shown) may also be used via a net to radio interface (NRI) to contact recipients of a recipient list via a radio signal.

Interfacing With a Subscriber

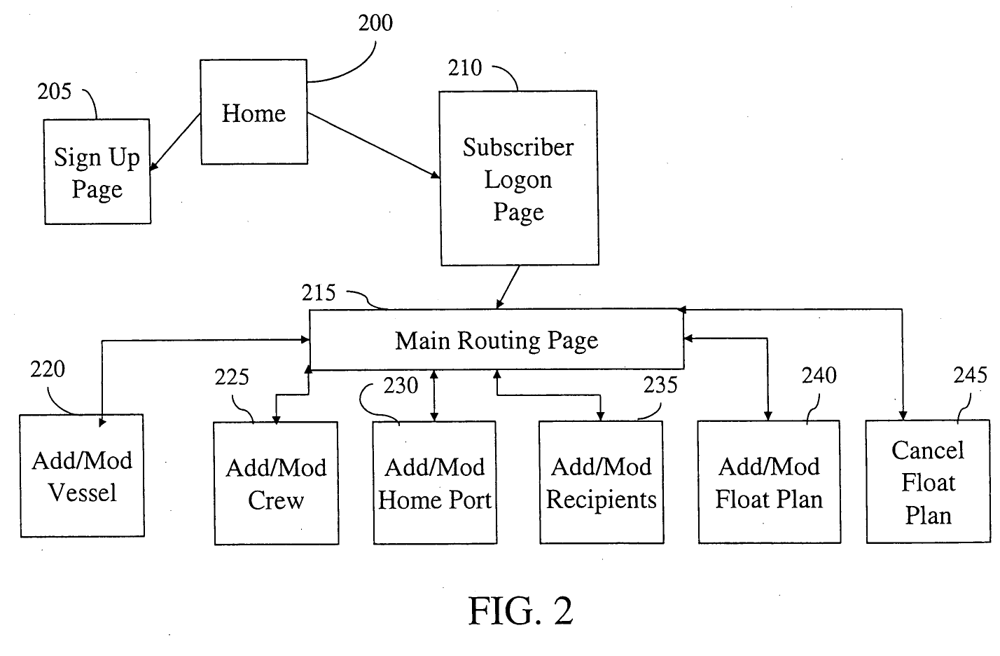

FIG. 2 is an example menu mapping for the alerting system according to an exemplary embodiment of the invention. While the menu map may be implemented using web pages accessible by a subscriber PC 130, a similar menu structure is used by subscribers that access the subscriber digital device 135 or subscriber analog device 140 to communicate with the alerting system 100.

For example purposes, FIG. 2 will be described in reference to web pages as served by web server 105. Initially, a potential subscriber will access a home page 200 via the potential subscriber's PC 130 or other web enabled device. From the home page 200 the potential subscriber may choose to go to a sign up page 205 to register as a subscriber. Alternatively, a current subscriber may go to the subscriber logon page 210 to logon. After the subscriber has logged on via the logon page 210, the subscriber is presented with the main routing page 215, which gives the subscriber several options. If the subscriber wishes to register a vessel, the subscriber may chose to go to the add/mod vessel page 220 to input the subscriber's vessel information. Similarly the subscriber may go to an add/mod crew page 225 to add or modify crew member information, an add/mod home page 230 to add or modify home port information, an add/mod recipients page 235 to add or modify recipient list information, an add/mod float plan page 240 to add or modify a float plan, or a cancel float plan page 245 to cancel a float plan. While not shown, the subscriber has the option to log off from the alerting system 100 from any screen after being logged on.

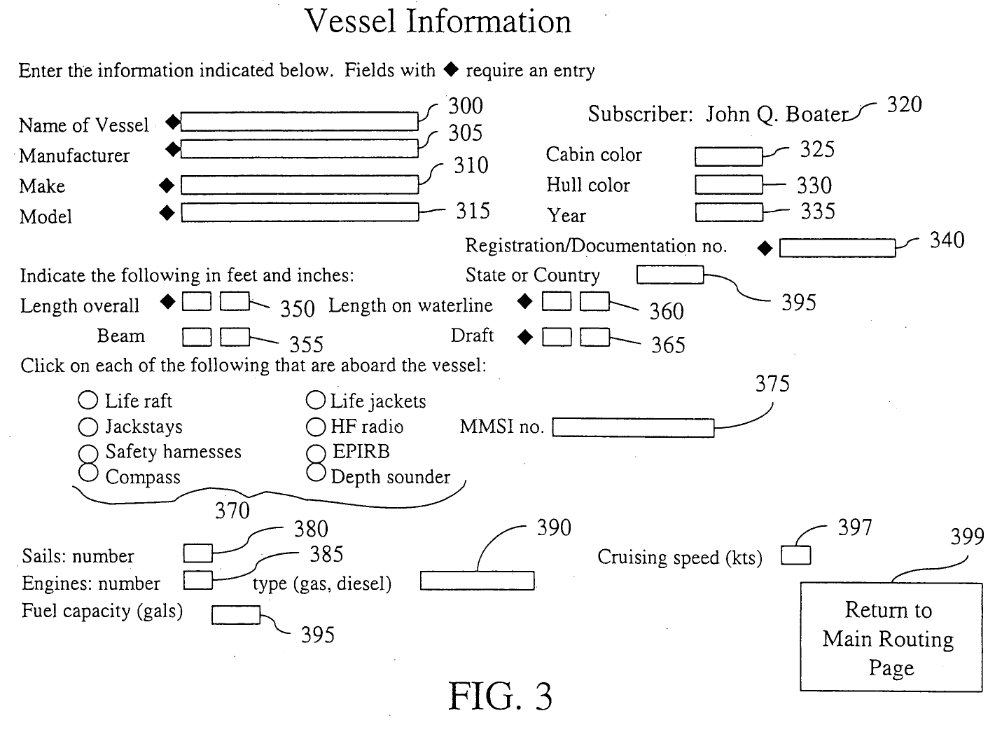

As an example, one of the web pages a subscriber may access, the add/mod vessel page 220, is shown in FIG. 3. FIG. 3 shows an example screen shot for adding vessel information according to an embodiment of the invention. The input screen of FIG. 3 includes the following input windows describing a vessel: name 300, manufacturer 305, make 310, model 315, cabin color 325, hull color 330, year built 335, registration/documentation number 340, state or country of registration 345, length overall 350, beam (width) 355, length on waterline 360, draft 365, MMSI number 375, number of sails 380, number of engines 385, fuel capacity 395, type of fuel 390, cruising speed 397. Also included are input buttons 370 that may be depressed to indicate that the vessel includes a life raft, jackstays, safety harnesses, compass, radar, life jackets, high frequency (HF) radio, emergency position-indicating radio beacon (EPIRB), depth sounder, etc. The subscriber's name is already entered into the add/mod vessel page at field 320 by the interface system 104. When modifications to the add/mod vessel page are complete, the subscriber may then select a link 399 to return to the main routing page 215.

Modifying a Float Plan

To create a float plan, a subscriber accesses the add/mod float plan page 240 and enters float plan information for a trip the subscriber will soon be taking. The float plan may include information related to a final destination; destination arrival time; starting point; date and time of travel start; route; the vessel used; name, age, sex, medical condition, and contact information of the crew and passengers; pets; time of departure; time of arrival; and recipients to notify in the event of an alert; etc.

Once a float plan is in place, a subscriber may modify the float plan to change the float plan information. Two additional options that are available to the subscriber in modifying the float plan are to declare an emergency and to cancel a float plan. When declaring an emergency, the subscriber is in essence stating that an alerting processor message is to be sent immediately to the designated recipients of a recipient list. When canceling a float plan prior to the arrival date and time, the subscriber is deactivating the float plan so that an alerting is not sent. While a subscriber may be canceling a float plan because the float plan has indeed been canceled, the subscriber may also cancel the float plan when the subscriber arrives at the final destination in the float plan. While canceling the float plan is an option, the subscriber should always cancel a float plan when arriving at the final destination. The cancellation of a message and declaration of an emergency may be in the form of web page entry, radio broadcast, telephone call, or other messaging means. For example, in the case of an emergency message, the message may actually be a distress signal including GPS information that could be added to an alerting processor message.

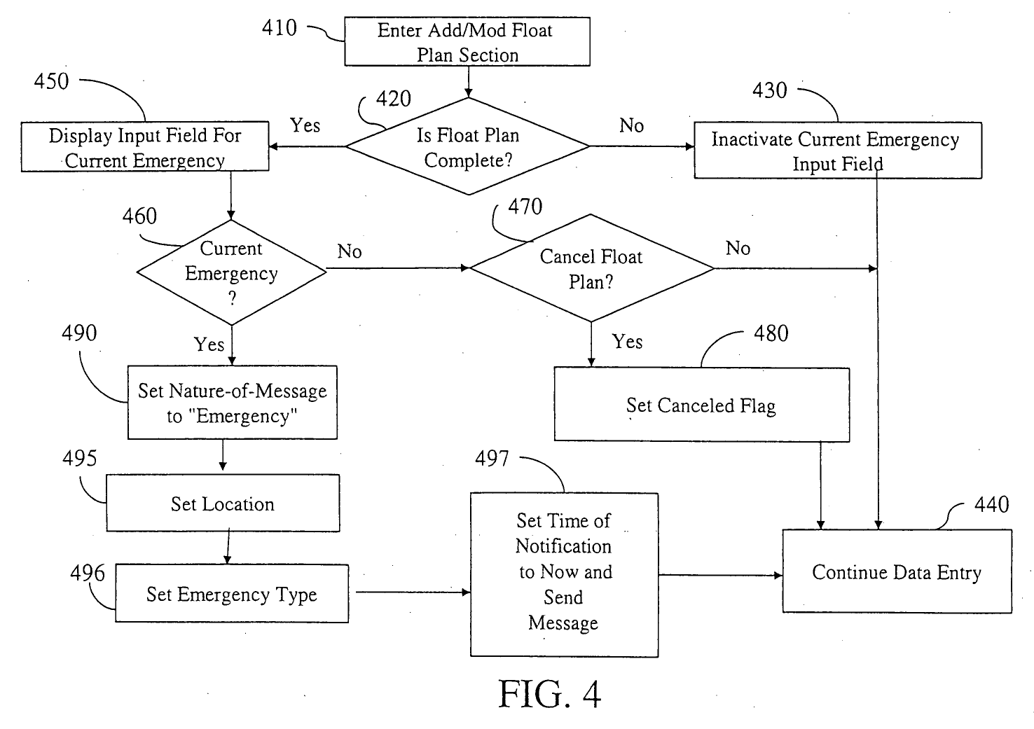

FIG. 4 is an example flow chart for declaring an emergency and canceling a float plan via the subscriber PC 130 and the web server 105 according to an embodiment of the invention. At block 410, the subscriber enters the add/mod float plan page 240. The database is asked whether there is a complete float plan on file for the subscriber at decision block 420. If not, the web server 105 inactivates the input field for a current emergency at block 430 and the subscriber is allowed to continue data entry at block 440. If at block 420 there is a complete float plan on file, the web server 105 displays an input field used for a current emergency 450. The subscriber is asked whether there is a current emergency at decision block 460. If not, the subscriber is asked whether the subscriber wants to cancel the float plan at block 470. If not the subscriber is allowed to continue data entry at block 440. If the subscriber cancels the float plan at decision block 470, a cancel flag is set at block 480 that deactivates the float plan and the subscriber is allowed to continue data entry at block 440. If at decision block 460 there is a current emergency, a nature-of-message flag is set to an emergency state at block 490. The subscriber is then asked to input the location of the emergency at block 495. Additionally, the subscriber is asked to select the type of emergency the subscriber is declaring at block 496. For example, the subscriber may be able to select from a list of emergency types such as sinking, injury, no gas, and other reasons why an emergency may be declared by the subscriber. Although not shown, additional information related to the emergency may be input between blocks 496 and 497. The messenger system 150 then sets the notification time to the current time and sends an alerting processor message at block 497. The subscriber is then allowed to continue data entry at block 440.

When entering data via a digital or analog device, input capabilities may not be as extensive as those for entering data via a web page. For such situations, the digital device server 110 and analog device server 115 may instead present an abridged version of the actions taken for modifying the float plan as shown in FIG. 4. For example, instead of continuing data entry at block 440, the analog or digital connection may be disconnected. Moreover, where there is no active float plan, the digital device server 110 or analog device server 115 may inform the subscriber that no action is possible and then disconnect the analog and digital connections.

Notification of Recipients

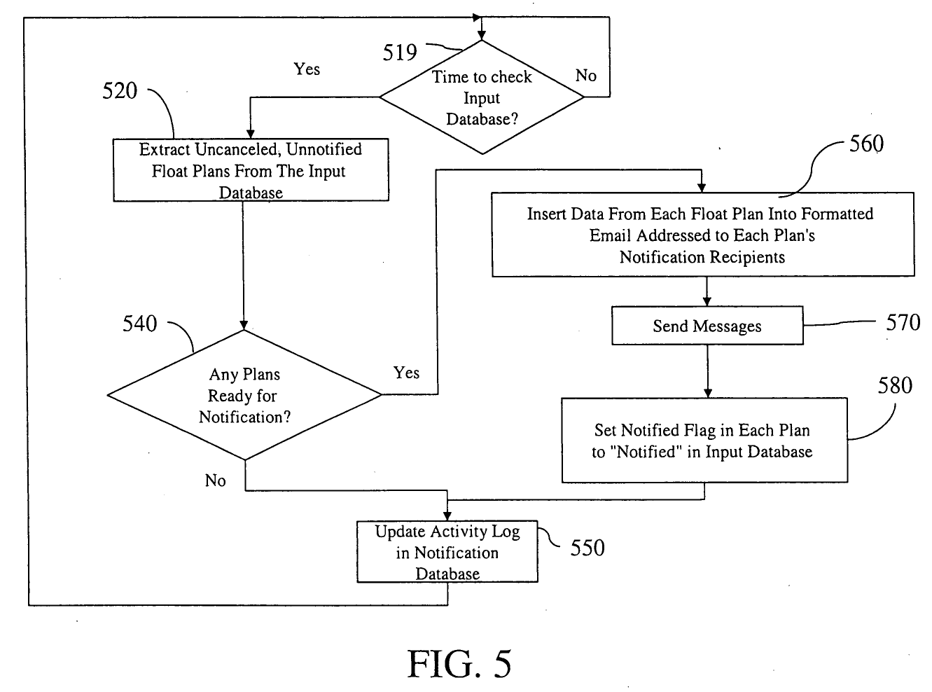

The notification processor 155 obtains float plan information from the input database 125 on a periodic basis. While a periodic interval is used, a well-known producer consumer algorithm may alternatively be used when obtaining float plan information. FIG. 5 is an example flow chart of notifying recipients according to an embodiment of the invention. Initially, the notification processor 155 determines whether it is time to check the input database 125 for float plan information at decision block 510. If the notification processor 155 determines that it is not time (e.g., a predetermined period of time has not been completed), block 510 is reexecuted. If it is time, the notification processor 155 extracts uncanceled, unnotified float plans from the input database 125 at block 520. The notification processor 155 then determines whether there are any float plans ready for notification at block 540. Float plans are ready for notification if they have not been canceled, they have not been previously selected for notification, and the requested notification time is earlier than the current time. If there are not any float plans ready for notification, an activity log in the notification database 175 is updated at block 550 and the process returns to decision block 510. If there are float plans ready for notification, data from each float plan is inserted into a formatted alerting processor message and addressed to each plan's notification recipient(s) at block 560. The alerting processor messages are sent at block 570 and, in block 580, a flag is set in the input database 125 for each plan for which a notification message was sent in block 570. The activity log in the notification database 175 is updated at block 550 and the process goes back to decision block 510. To prevent issuing a flood of messages, the number of allowed recipients may be limited.

Alerting Processor Messages

When preparing the alerting processor messages, the notification processor 155 formats the messages according to the format acceptable to a media server sending the alerting processor message. For example, the notification processor 155 formats the alerting processor message into an email format for the email server 160, fax format for the fax server 165, and voice format for the telephony server 170. Alternatively, the notification processor 155 may output to the servers one generic format (e.g., ASCII text) and the Email Server 160, fax server 165, and telephony server 170 reformat the alerting processor message to their respective transmission types. Moreover, in another embodiment, a human may receive the information from the notification processor and send the message via servers 160, 165, and 170. In this embodiment the human may instead simply call a recipient and convey the alerting processor message to the recipient directly.

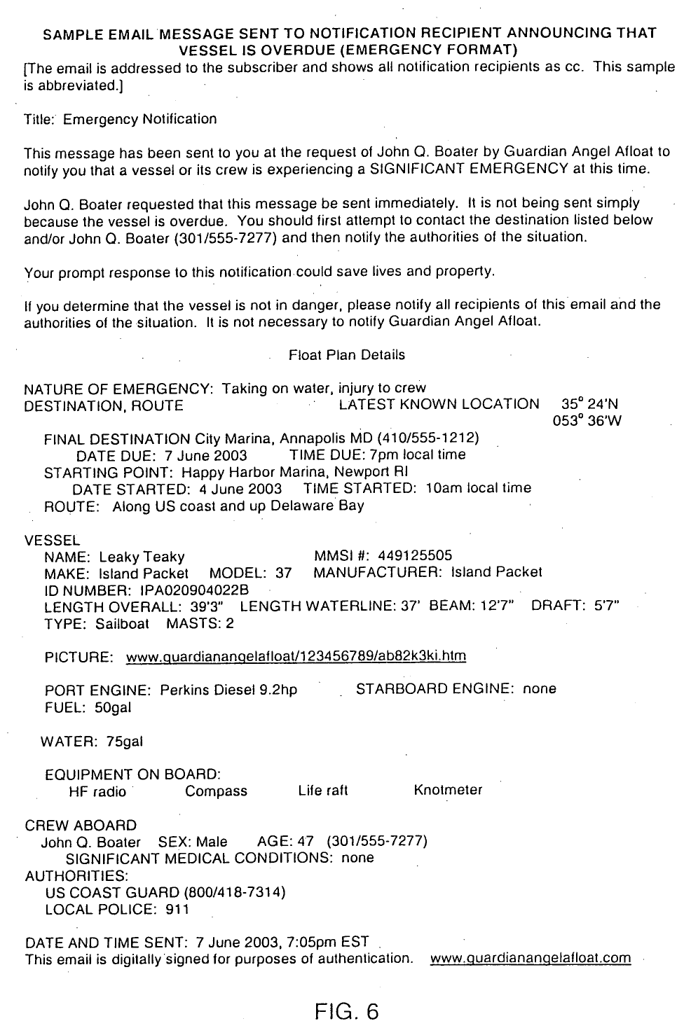

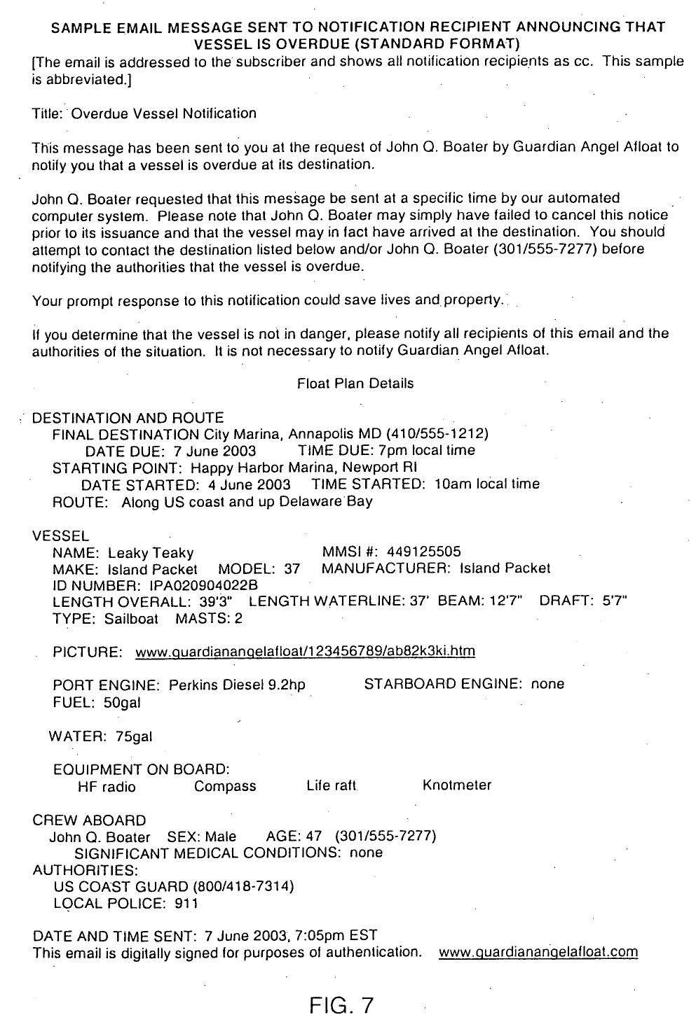

FIGS. 6 and 7 are examples of alerting processor messages according to an embodiment of the present invention. FIG. 6 shows an example emergency notification message. An emergency notification message is an alerting processor message that is sent to a recipient when the subscriber indicates that an emergency situation has been encountered. FIG. 7 shows an example of an overdue vessel notification. An overdue vessel notification message is an alerting processor message sent when a subscriber has not canceled a float plan prior to a predetermined period of time after the destination arrival time.

For example purposes, email alerting processor messages are shown in FIGS. 6 and 7. However, similar information may be delivered via the fax server 165 or telephony server 170. The alerting processor messages include a title and introductory paragraph. This information may be default information with specific fields inserted or composed by the subscriber as input into the add/mod recipients page 235 shown in FIG. 2. The destination and route information, crew aboard information, vessel information, and authorities information are retrieved from previous subscriber input into the add/mod float plan page 240, add/mod crew page 225, add/mod vessel page 220, and add/mod recipients page 235, respectively, also shown in FIG. 2. In addition to the above information, sender and authentication information may also be included by the notification processor 155. The sender and authentication information may include, among other things, the date and time of the message being sent, who the sender of the message is, and information related to message authentication. Moreover, an emergency notification message may include nature of emergency information, the emergency location, or other details related to the emergency. The emergency information is retrieved from previous subscriber input into the add/mod float plan page 240. Alternatively, a commercially available digital signature system may be used to authenticate each message.

### Conclusion

The invention provides a system where a processing center is used by a subscriber to file a float plan. Alerting processor messages are sent to subscriber-designated recipients by the processing center if the subscriber fails to send a float plan cancellation message or the subscriber requests the alerting processor message to be immediately sent.

The invention provides many benefits. Having a processing center responsible for sending alerting processor messages is desirable to boaters because: boaters may not want to involve their family and friends needlessly with a float plan; boaters see multiple dispersions of float plans as an invasion of privacy unless needed in an emergency; boaters may not want to broadcast a float plan to several parties without an actual emergency; boaters may fear that an alerting is not likely to be invoked if a float plan is left with someone of questionable trustworthiness; boaters may also fear that a single recipient of a float plan may not be attentive to a vessel becoming overdue or may hesitate to inform the authorities; boaters may be hesitant to ask someone to take on the alerting responsibility or they know that it makes the person nervous to have the responsibility of making decisions; the Coast Guard does not accept float plans in any form; and filing a float plan can be an elaborate effort for a casual weekend of boating.

Having a processing center to which a boater may submit his/her float plans and which also has the responsibility of sending alerting processor messages helps a boater overcome many of the above obstacles. Enhancing the ease and confidence of filing a float plan also provides the added benefit of encouraging more boaters to file float plans, thus, making boating safer.

Although the example embodiments of the present invention described above have been described as pertaining to travel by boat, alternative modes of transportation may also be supported by the invention such as ground transportation and air transportation. Examples of ground transportation include foot, bicycle, car, motorcycle, subway, train, and truck. Examples of air transportation include airplane, glider, jet, and helicopter. Further, although the example embodiments of the present invention described above have pertained primarily to recreational boating, the invention is also applicable to commercial boating. Still further, in example embodiments of the present invention the invention may be used to support vacation activities or any other activity where a subscriber will be separate from a recipient and the subscriber would like a third party to alert the recipient if the subscriber doesn't cancel the sending of a message prior to a specific time.

It is noted that the functional blocks in the example embodiments of FIGS. 1-6 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

This specification describes various exemplary embodiments of the method and system of the present invention. The scope of the claims are intended to cover various modifications and equivalent arrangements of the illustrative embodiments disclosed in this specification. Therefore, the following claims should be accorded the reasonably broadest interpretations to cover modifications, equivalent structures in features which are consistent with the spirit and the scope of the invention disclosed herein.

What is claimed is:

1. A method comprising:
receiving; by a processing center, travel itinerary information from a subscriber, the travel itinerary information including a destination arrival time; and
sending, by the processing center, a processor message to a recipient other than the subscriber when a cancellation message is not received from the subscriber prior to a predetermined period of time after the destination arrival time, the processor message including a portion of the travel itinerary information.

2. The method of claim 1, wherein the processor message is an electronic message that is created when the cancellation message is not received from the subscriber prior to a predetermined period of time after the destination arrival time.

3. The method of claim 1, wherein the processor message is at least one of an Email, telephone call, facsimile, video, pager message, and wireless transmission.

4. The method of claim 1, wherein the travel itinerary information includes at least one of boating travel itinerary information and a vehicle picture.

5. The method of claim 1, further comprising storing subscriber information and a recipient list in a database.

6. The method of claim 5, further comprising retrieving a portion of the subscriber information and a portion of the recipient list from the database.

7. The method of claim 5, wherein the processor message, includes a portion of the subscriber information.

8. The method of claim 5, wherein the sending of the processor message is to at least one recipient on the recipient list.

9. The method of claim 1, wherein the processing center is comprised of at least one of a plurality of computers and a plurality of databases.

10. A method comprising:
receiving, by a processing center, travel itinerary information from a subscriber, the travel itinerary information including a travel start time and route information; and
sending, by the processing center, a processor message, including a portion of the travel itinerary information, to a recipient other than the subscriber when a subscriber message is received from the subscriber.

11. The method of claim 10, wherein the processor message is an electronic message that is created when a subscriber message is received from the subscriber.

12. The method of claim 11, wherein the electronic message is at least one of an Email, telephone call, facsimile, video, pager message, and wireless transmission.

13. The method of claim 10, wherein the travel itinerary information includes at least one of boating travel itinerary information and a vehicle picture.

14. The method of claim 10, further comprising storing subscriber information and a recipient list in a database.

15. The method of claim 14, further comprising retrieving a portion of the subscriber information and a portion of the recipient list from the database.

16. The method of claim 14, wherein the processor message, includes a portion of the subscriber information.

17. The method of claim 14, wherein the sending of the processor message is to at least one recipient on the recipient list.

18. The method of claim 10, wherein the subscriber message includes an indicator that indicates at least one of a format and a content of the processor message to be sent.

19. The method of claim 10, wherein the processing center is comprised of at least one of a plurality of computers and a plurality of databases.

20. The method of claim 10, wherein at least one of a format and a content of the processor message depends on settings set for each recipient.
